(19) United States
(12) Patent Application Publication
(10) Pub. No.: US 2014/0305312 A1
(43) Pub. Date: Oct. 16, 2014

(54) Coffee Maker

(71) Applicant: Tien-Hua Lin, New Taipei City (TW)

(72) Inventor: Tien-Hua Lin, New Taipei City (TW)

(21) Appl. No.: 13/862,575

(22) Filed: Apr. 15, 2013

(51) Int. Cl. A47J 31/44

(52) U.S. Cl. CPC A47J 31/4403
USPC 99/275; 248/346.01

(57) ABSTRACT

A coffee maker includes a main body and a movable module. The main body includes a cup holder, a liquid container, and a frame. The cup holder carries a coffee cup set. The liquid container is disposed on the cup holder for accommodating a liquid. The frame supports the liquid container. The movable module connects the cup holder or the frame to translate and rotate the frame for more evenly melting the coffee.

### BACKGROUND OF THE INVENTION

1. Field of the Invention

The invention relates to a coffee maker and especially a coffee maker capable of more evenly melting the coffee.

2. Description of the Related Art

A known coffee making method includes: putting a filter cup on a coffee cup or other container; rolling a filter paper into a funnel shape for fitting in filter cup; putting the coffee powder in the funnel-shaped filter paper; pouring a hot water in the filter paper and melting the coffee powder for making coffee; filtering out the coffee powder grounds by the filter paper; and dripping the filtered coffee in a coffee cup for drinking.

The aforementioned coffee making method cannot thoroughly and evenly melt the coffee powder, and the coffee made by the aforementioned method is not enough mellow.

### BRIEF SUMMARY OF THE INVENTION

According to the above or other objects, the invention provides a coffee maker for more evenly melting the coffee.

In an exemplary embodiment of the coffee maker according to the invention, the coffee maker includes a main body and a movable module. The main body includes a cup holder for carrying a coffee cup set. The movable module connects to the cup holder to translate and rotate the frame.

In another exemplary embodiment, the movable module includes a driving unit and a transmission unit, and the driving unit generates a power to drive the cup holder through the transmission unit.

In yet another exemplary embodiment, the transmission unit includes a ring gear and a gear. The gear engages inner peripheral surfaces of the ring gear. The driving unit connects to the gear and drives the gear to move along the inner peripheral surfaces. The cup holder eccentrically connects to the gear.

In another exemplary embodiment, the driving unit can be a spring.

In yet another exemplary embodiment, the driving unit can be a motor and the transmission unit can include a deceleration gear train. The motor drives the cup holder through the deceleration gear train.

In another exemplary embodiment, the main body further includes a liquid container, and the liquid container is disposed on the cup holder for accommodating a liquid.

In yet another exemplary embodiment, the liquid container includes a control valve to control a volume of the liquid for entering the coffee cup set.

In another exemplary embodiment, the coffee maker further includes a frame for supporting the liquid container.

In yet another exemplary embodiment, the aforementioned frame can be an extendable frame.

From another perspective of the invention, a coffee maker is provided and the coffee maker includes a main body and a movable module. The main body includes a cup holder, a liquid container, and a frame. The cup holder carries a coffee cup set. The liquid container is disposed on the cup holder for accommodating a liquid. The frame supports the liquid container. The movable module connects to the frame to translate and rotate the frame.

In an exemplary embodiment, the movable module includes a driving unit and a transmission unit, and the driving unit generates a power to drive the frame through the transmission unit.

In another exemplary embodiment, the transmission unit includes a ring gear and a gear. The gear engages inner peripheral surfaces of the ring gear. The driving unit connects to the gear and drives the gear to move along the inner peripheral surfaces. The frame eccentrically connects to the gear.

In yet another exemplary embodiment, the driving unit can be a spring.

In another exemplary embodiment, the driving unit can be a motor and the transmission unit can include a deceleration gear train. The motor drives the cup holder through the deceleration gear train.

In yet another exemplary embodiment, the liquid container includes a control valve to control a volume of the liquid entering the coffee cup set.

In another exemplary embodiment, the aforementioned frame can be an extendable frame.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a coffee maker in accordance with a first embodiment of the invention;

FIG. 2 shows partial parts of the transmission unit of the coffee maker in accordance with the first embodiment of the invention;

FIG. 3 shows other parts of the transmission unit of the coffee maker in accordance with the first embodiment of the invention;

FIG. 4 shows a motion trace of a linking part of the transmission unit of the coffee maker in accordance with the first embodiment of the invention;

FIG. 5 shows a coffee making method using the coffee maker in accordance with the first embodiment of the invention;

FIG. 6 shows a coffee maker in accordance with a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

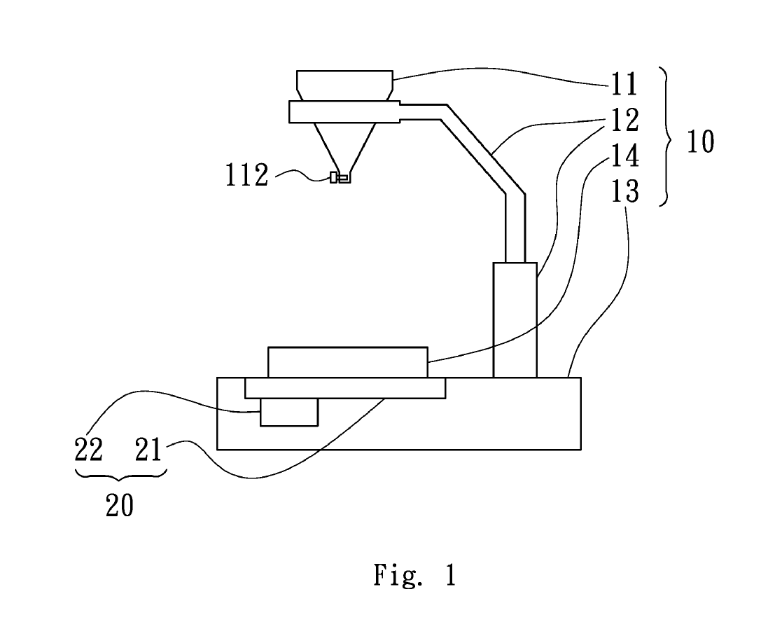

Referring to FIG. 1, the coffee maker in accordance with a first embodiment of the invention includes a main body 10 and a movable module 20.

The main body 10 includes a liquid container 11, a frame 12, a base 13, and a cup holder 14, wherein the frame 12 and the cup holder 14 are disposed on the base 13 and the liquid container 11 is disposed on the frame 12.

The movable module 20 includes a transmission unit 21 and a driving unit 22, and the driving unit 22 can be a motor, a spring, or any unit capable of generating power. The transmission unit 21 is disposed in the base 13. The driving unit 22 generates a power to translate and/or rotate the cup holder 13 through the transmission unit 21.

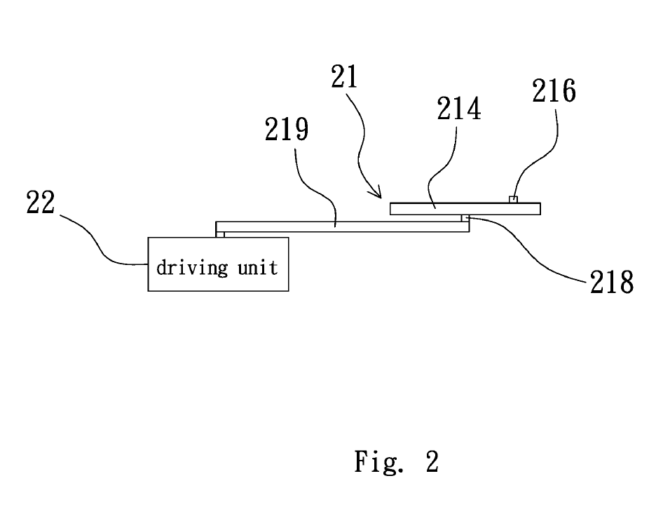

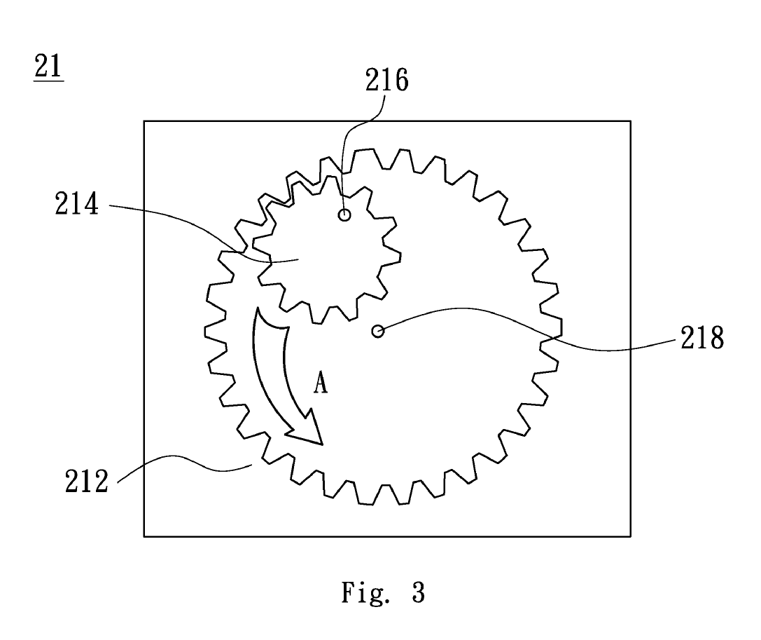

Referring to FIG. 2 and FIG. 3, the transmission unit 21 includes a linkage 219, a linking part 218, a gear 214, a linking part 216, and a ring gear 212. One end of the linkage 219 connects to the driving unit 22, and the other end of the linking part 219 connects to the center of the gear 214 through the linking part 218. The gear 214 engages the inner peripheral surfaces of the ring gear 212, and the driving unit 22 generates a rotation force to drive the gear 214 to move along the inner peripheral surfaces of the ring gear 212 through linking parts 218 and the linkage 219 (shown as arrow A in FIG. 3). The linking part 216 connects the gear 214 and the cup holder 14 so that the driving unit 22 can further drive the cup holder 14 through linking part 216.

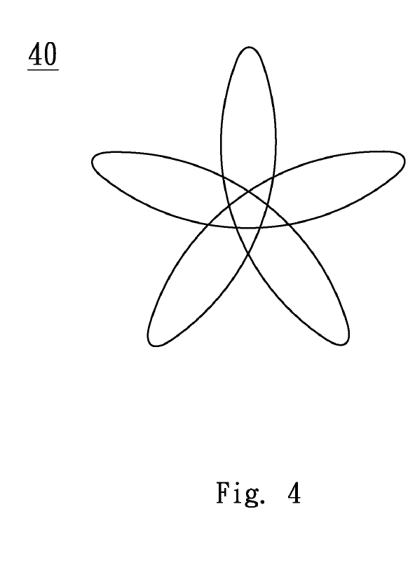

One thing to be noted, the linking part 216 does not connect to the center of the gear 214 but eccentrically connects to the gear 214. Therefore, when the gear 214 moves along the inner peripheral surfaces of the ring gear 212, the linking part 216 simultaneously translates and rotates. The motion trace of the linking part 216 depends on the location of the linking part 216, and the motion trace 40 in FIG. 4 is shown for example without limiting the implementation of the invention. Because the cup holder 14 connects to the linking part 216, the motion trace of the cup holder 14 is same as that of the linking part 216.

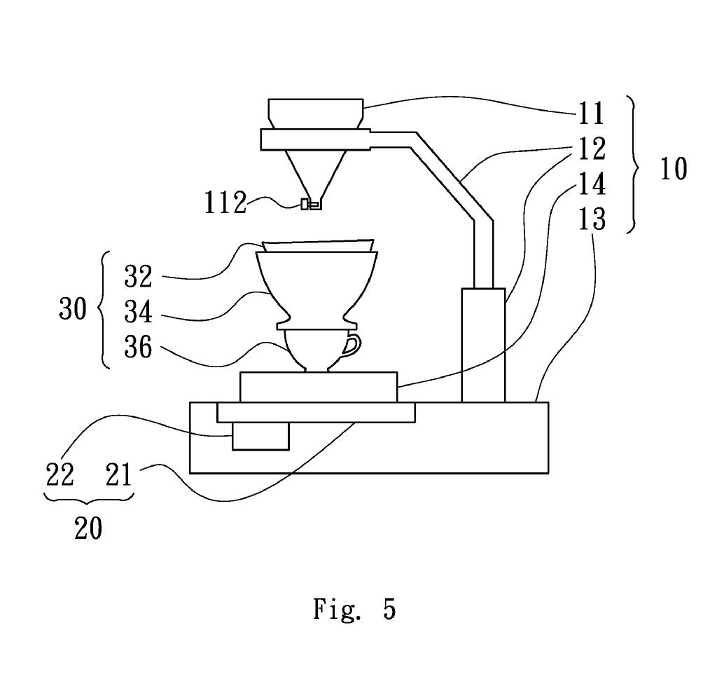

Referring to FIG. 5, the method of making coffee is as follows: providing a coffee cup set 30 including a filter cup 34, a filter paper 32, a coffee powder (not shown), and a coffee cup 26; putting the coffee cup set 30 on the cup holder 14 and adding hot water in the liquid container 11; adjusting and turning on the movable module 20 to drive the cup holder 14 so that the coffee cup set 30 simultaneously translates and rotates. Due to the continuously changing motion trace of the coffee cup holder 30 with respect to the liquid container 11, a good coffee making effect is obtained.

Furthermore, the frame 12 is extendable and its height can be adjusted according to the height of the coffee cup set 30 or other practical need.

Furthermore, the liquid container 11 can include a control valve to control a volume of the liquid such as hot water or milk entering the coffee cup set.

In an embodiment of the invention, when the driving unit 22 is a motor, the transmission unit 21 can include a deceleration gear train (not shown) to reduce the output speed from the motor and to increase the output torque at the same time for driving the cup holder 14 and the coffee cup set 30.

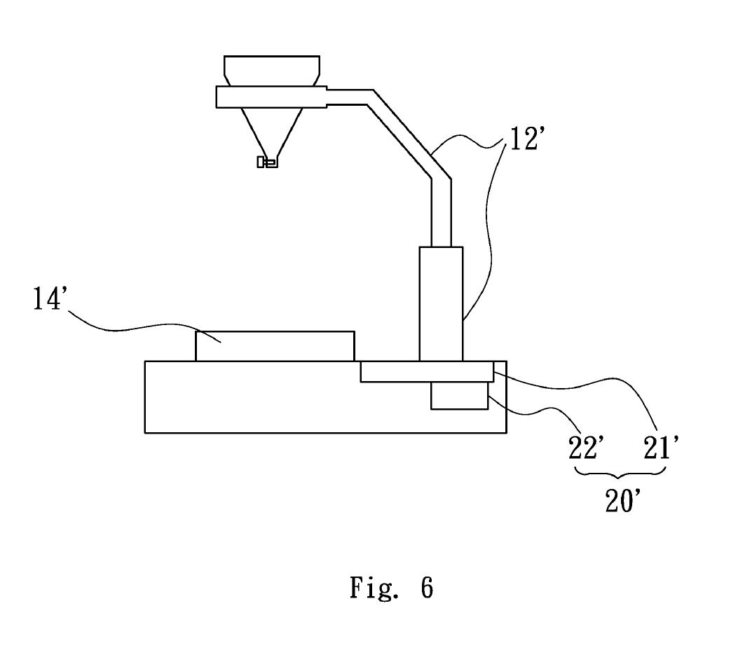

Referring to FIG. 6, a coffee maker in according with a second embodiment of the invention is shown. In this embodiment, a transmission unit 21′ connects to a frame 12′, and a driving unit 22′ drives the frame 12′ rather than the cup holder 14′ through the transmission unit 21′. This concept can similarly generate a continuously changing motion trace to obtain an evenly coffee making effect. Because other parts are similar with or identical to those of the first embodiment, their detail description is omitted.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A coffee maker, comprising:
a main body including a cup holder for carrying a coffee cup set; and
a movable module connecting to the cup holder to translate and rotate the cup holder.

2. The coffee maker as claimed in claim 1, wherein the movable module includes a driving unit and a transmission unit, and the driving unit generates a power to drive the cup holder through the transmission unit.

3. The coffee maker as claimed in claim 2, wherein the transmission unit includes a ring gear and a gear and the gear engages inner peripheral surfaces of the ring gear, and the driving unit connects to the gear and drives the gear to move along the inner peripheral surfaces, and the cup holder eccentrically connects to the gear.

4. The coffee maker as claimed in claim 2, wherein the driving unit is a spring.

5. The coffee maker as claimed in claim 2, wherein the driving unit is a motor.

6. The coffee maker as claimed in claim 5, wherein the transmission unit includes a deceleration gear train, and the motor drives the cup holder through the deceleration gear train.

7. The coffee maker as claimed in claim 1, wherein the main body further includes a liquid container, and the liquid container is disposed on the cup holder for accommodating a liquid.

8. The coffee maker as claimed in claim 7, wherein the liquid container includes a control valve to control a volume of the liquid entering the coffee cup set.

9. The coffee maker as claimed in claim 7, wherein the coffee maker further includes a frame for supporting the liquid container.

10. The coffee maker as claimed in claim 9, wherein the frame is an

11. A coffee maker, comprising:
a main body including a cup holder, a liquid container, and a frame, wherein the cup holder is configured to carry a coffee cup set, the liquid container is disposed on the cup holder for accommodating a liquid, and the frame supports the liquid container; and
a movable module connected to the frame to translate and rotate the frame.

12. The coffee maker as claimed in claim 11, wherein the movable module includes a driving unit and a transmission unit, and the driving unit generates a power to drive the frame through the transmission unit.

13. The coffee maker as claimed in claim 12, wherein the transmission unit includes a ring gear and a gear, the gear engages inner peripheral surfaces of the ring gear, the driving unit connects to the gear and drives the gear to move along the inner peripheral surfaces, and the frame eccentrically connects to the gear.

14. The coffee maker as claimed in claim 12, wherein the driving unit is a spring.

15. The coffee maker as claimed in claim 12, wherein the driving unit is a motor.

16. The coffee maker as claimed in claim 15, wherein the transmission unit includes a deceleration gear train, and the motor drives the frame through the deceleration gear train.

17. The coffee maker as claimed in claim 11, wherein the liquid container includes a control valve to control a volume of the liquid entering the coffee cup set.

18. The coffee maker as claimed in claim 11, wherein the frame is an extended frame.
